(19) United States
(12) Patent Application Publication
(10) Pub. No.: US 2025/0142311 A1
(43) Pub. Date: May 1, 2025

(54) SERVER APPARATUS, COMMUNICATION CONTROL METHOD, TERMINAL APPARATUS, AND BASE STATION

(71) Applicant: HONDA MOTOR CO., LTD., Tokyo (JP)

(72) Inventors: Takafumi Saito, Tokyo (JP); Kenji Nakanishi, Tokyo (JP)

(73) Assignee: HONDA MOTOR CO., LTD., Tokyo (JP)

(21) Appl. No.: 19/008,270

(22) Filed: Jan. 2, 2025

Related U.S. Application Data
(63) Continuation of application No. PCT/JP2022/027212, filed on Jul. 11, 2022.

(51) Int. Cl. H04W 4/90; H04W 4/40; H04W 64/00; H04W 92/18

(52) U.S. Cl. CPC H04W 4/90; H04W 4/40; H04W 64/00; H04W 92/18

(57) ABSTRACT

There is provided a server apparatus including a communication unit to communicate with terminal apparatuses operating as V2X application clients, and a server processing unit to operate as a V2X application server. The server processing unit can access a database indicating a neighbor relationship between predefined geographical areas in which first and second geographical areas being indicated as neighboring areas. The server processing unit configures each terminal apparatus to receive, via a sidelink, an alarm message regarding road safety from another terminal apparatus, receives location information of a first terminal apparatus, determines that the first terminal apparatus is located in the first geographical area, and instructs the first terminal apparatus to relay, via the sidelink, the alarm message received in the first geographical area so that a second terminal apparatus in the second geographical area can receive the relayed message.

### CROSS-REFERENCE TO RELATED APPLICATION(S)

This application is a continuation of International Patent Application No. PCT/JP2022/027212 filed on Jul. 11, 2022, the entire disclosure of which is incorporated herein by reference.

### BACKGROUND OF THE INVENTION

### Field of the Invention

The present invention relates to a server apparatus, a communication control method, a terminal apparatus, and a base station.

### Description of the Related Art

In a fourth generation cellular communication technology, also referred to as Long Term Evolution (LTE) standardized by the third generation partnership project (3GPP), it is assumed that a sidelink, which is a direct radio link between terminals, is used for vehicle-to-everything (V2X) communication (see section 5.6 of 3GPP TS 36.300 v16.7.0 (Dec. 23, 2021)). In 3GPP TS 22.185 v16.0.0 (Jul. 16, 2020), it is described that V2X may include the following four types of concepts:
V2V: Vehicle-to-Vehicle
V2I: Vehicle-to-Infrastructure
V2N: Vehicle-to-Network
V2P: Vehicle-to-Pedestrian

In a fifth generation cellular communication technology also referred to as New Radio (NR), a radio access network (RAN) supports both a V2X sidelink of 4G and an NR sidelink of 5G (see section 16.9 of 3GPP TS 38.300 v16.8.0 (Dec. 23, 2021)). For example, a terminal (also referred to as user equipment (UE)) that performs sidelink communication establishes a radio link referred to as a PC5 interface with a communication partner terminal, and performs V2X communication on a communication resource scheduled by the RAN or a communication resource autonomously selected from a resource pool assigned in advance. In the V2X sidelink of 4G, only broadcast of the V2X message is supported, whereas in the NR sidelink of 5G, broadcast, groupcast, and unicast of the V2X message are supported.

US2020/0312142 discloses a technology in which a V2X communication-capable terminal apparatus mounted on a vehicle evaluates road safety in real time and, when it is determined that there is some threat, alerts the user of the vehicle or another user.

“Cellular-V2X Technology Overview” (Qualcomm Technologies Inc., 2019, 80-PE732-63 Rev B, Searched on May 9, 2022, https://www.qualcomm.com/media/documents/files/c-v2x-technology-overview.pdf) discloses results of tests in which communication ranges of V2V message exchange using 4G V2X sidelink are evaluated on actual roads. According to the results of the tests, in a situation in which a line of sight is maintained between vehicles, it was possible to exchange messages with good quality up to a vehicle interval of 1,000 meters, whereas in a situation in which there was an obstacle between the vehicles, the maximum vehicle interval at which it was possible to exchange messages with good quality was 400 meters.

By notifying of a presence of a threat regarding safety to and from V2X terminals as with the technology disclosed by US2020/0312142, it is possible to seek to enhance user's safety. However, the limited communication range of V2X communication has been one of constraints in improving the safety.

### SUMMARY OF THE INVENTION

In view of the above points, the present disclosure aims to provide a mechanism capable of further improving safety of a user related to road traffic.

According to the present disclosure, there is provided a server apparatus including: a communication unit adapted to communicate with one or more terminal apparatuses that operate as clients of a vehicle-to-everything, V2X, application, and a server processing unit adapted to operate as a server of the V2X application, wherein the server processing unit is capable of accessing a database that indicates a neighbor relationship between geographical areas for a plurality of geographical areas predefined for the V2X application, a first geographical area and a second geographical area being indicated as neighboring areas by the database, and the server processing unit is adapted to: configure each of the one or more terminal apparatuses to receive, via a sidelink, an alarm message regarding road safety sent from another terminal apparatus; receive location information of a first terminal apparatus via the communication unit; determine, on the basis of the location information, that the first terminal apparatus is located in the first geographical area; and instruct the first terminal apparatus to relay, via the sidelink, the alarm message received in the first geographical area so that a second terminal apparatus located in the second geographical area can receive the relayed alarm message.

A corresponding communication control method, terminal apparatus and base station are also provided.

Further features of the present invention will become apparent from the following description of exemplary embodiments (with reference to the attached drawings).

### BRIEF DESCRIPTION OF THE DRAWINGS

FIG. 1 is a copy of Figure 16.9.1-1 of 3GPP TS 38.300 v16.8.0;

FIG. 2 is a copy of Figure 6.2-2 of 3GPP TS 23.286 v17.3.0;

FIG. 3 is a schematic diagram illustrating an example of a configuration of a V2X communication system according to an embodiment;

FIG. 4 is a block diagram illustrating an example of a configuration of a server apparatus according to an embodiment;

FIG. 5 is an explanatory diagram for describing an example of a definition of geographical areas according to an embodiment;

FIG. 6A is an explanatory diagram illustrating a first example of a message format for a relay instruction;

FIG. 6B is an explanatory diagram illustrating a second example of a message format for a relay instruction;

FIG. 6C is an explanatory diagram illustrating a third example of a message format for a relay instruction;

FIG. 6D is an explanatory diagram illustrating a fourth example of a message format for a relay instruction;

FIG. 7 is a block diagram illustrating an example of a configuration of a UE according to an embodiment;

FIG. 8 is a block diagram illustrating an example of a configuration of a base station according to an embodiment;

FIG. 9 is a sequence diagram illustrating an example of a flow of processing according to a first embodiment example; and

FIG. 10 is a sequence diagram illustrating an example of a flow of processing according to a second embodiment example.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### 1. Basic System Architecture for V2X Service

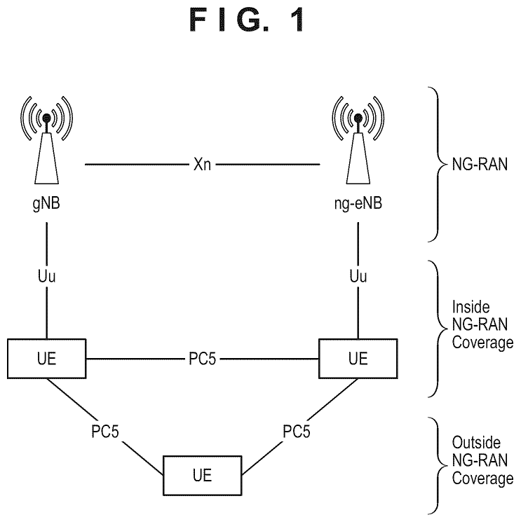

FIG. 1 is a copy of Figure 16.9.1-1 of 3GPP TS 38.300 v16.8.0, illustrating an example of an NG-RAN architecture for a 5G system. Here, a gNB is a 5G base station connected to a 5G core network (not illustrated). Meanwhile, an ng-eNB is a 4G base station connected to a 5G core network. In this example, the gNB and the ng-eNB are connected to each other via an Xn interface. A user equipment (UE) is a terminal apparatus served by the gNB or the ng-eNB. A radio link for transmitting and receiving user data between the UE and the gNB or the ng-eNB is referred to as a Uu interface. A PC5 interface is a communication link established between two UEs. Such a direct communication link between UEs that does not pass through a base station is also referred to as a sidelink. A next generation (NG)-radio access network (RAN) supports such a PC5 interface. The PC5 interface can be identified by a pair of a layer 2 ID (source layer-2 ID) assigned to the UE on the transmission side and a layer 2 ID (destination layer-2 ID) assigned to the UE on the reception side. The resource used for communication is scheduled by a base station (scheduled resource allocation), or is autonomously selected by the UE from a preset resource pool (autonomous resource selection). In the 5G system, such a PC5 interface can be utilized for the V2X service.

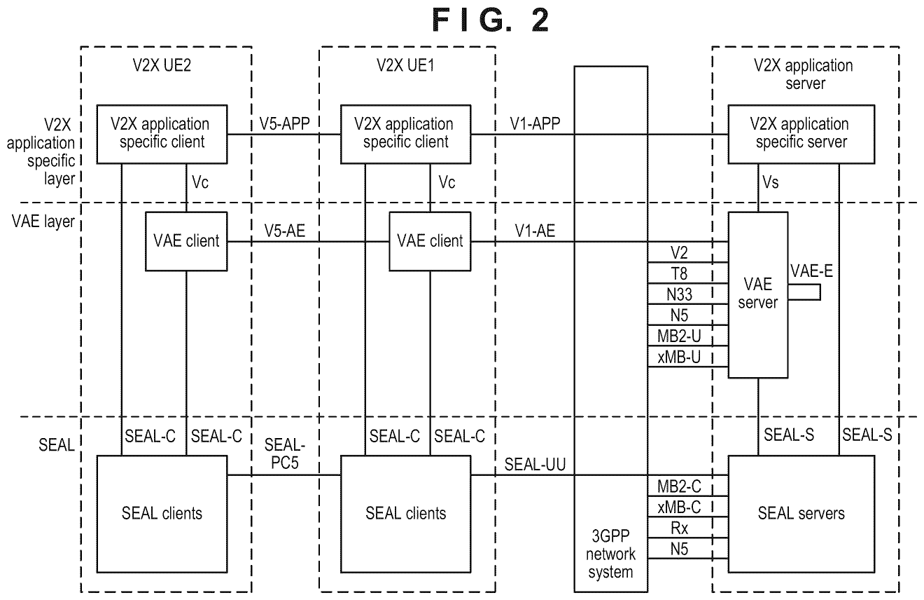

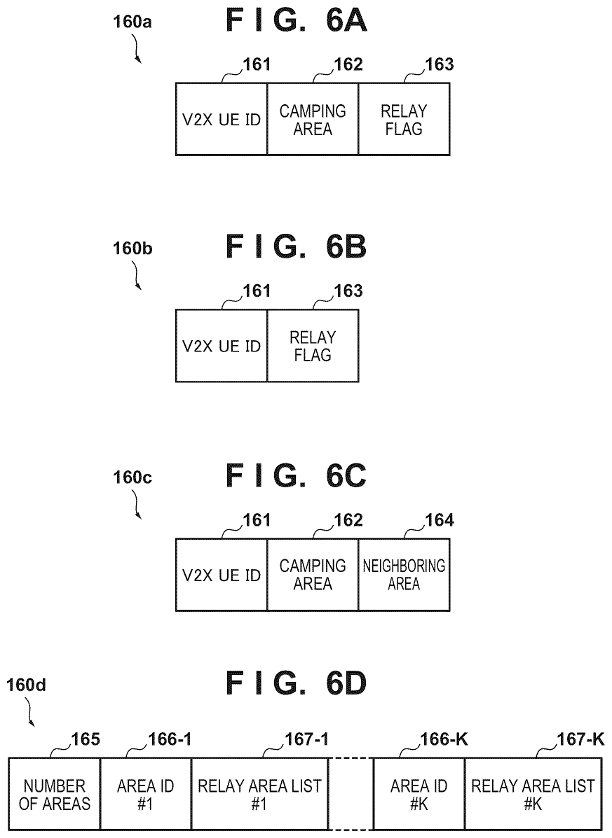

FIG. 2 is a copy of Figure 6.2-2 of 3GPP TS 23.286 v17.3.0, illustrating a hierarchical functional model of a V2X application. In the functional model of FIG. 2, the UE operates as a client (V2X UE) of the V2X application. On the other hand, a server of the V2X application is typically deployed in an Internet Protocol (IP) network and communicates with one or more V2X UEs via a 3GPP network system including a RAN and a core network. A V2X UE (V2X UE1 in FIG. 2) located inside the coverage of the NG-RAN can communicate with a V2X UE (V2X UE2 in FIG. 2) located outside the coverage via a sidelink.

The functional model of FIG. 2 has a hierarchical structure including a V2X application specific layer, a V2X application enabler (VAE) layer, and a service enabler architecture layer (SEAL) in order from the top in FIG. 2.

The SEAL is a layer that provides basic services common to various applications including V2X and other types of applications. Services related to the V2X application provided in the SEAL include, for example, location management, group management, configuration management, identity management, key management, and network resource management. The V2X UE includes SEAL clients, and the V2X application server includes SEAL servers. A SEAL-PC5 is an interface between V2X UEs in the SEAL. A SEAL-UU is an interface between a V2X UE and the V2X application server in the SEAL. Details of the functions of the SEAL clients and the SEAL servers are described in 3GPP TS 23.434 v17.5.0.

The VAE layer is a layer that supports a V2X application specific layer by interpreting a service provided by the SEAL for V2X application use. The V2X UE includes a VAE client, and the V2X application server includes a VAE server. The functions provided by the VAE client may include, for example, registration of the VAE client to the VAE server for reception of V2X messages, provision of application-level location information to the VAE server, reception of communication configuration information from the VAE server, and support for dynamic group management. The functions provided by the VAE server may include, for example, accepting registration of VAE clients, tracking the location of V2X UEs at the application level, providing communication configuration information, and supporting delivery of V2X messages. A V5-AE is an interface between V2X UEs in the VAE layer. A V1-AE is an interface between a V2X UE and the V2X application server in the VAE layer.

The V2X application specific layer is a layer that provides functionality specific to individual V2X applications with the assistance of the VAE layer. The V2X UE includes a V2X application specific client, and the V2X application server includes a V2X application specific server. A V5-APP is an interface between V2X UEs in the V2X application specific layer. A V1-APP is an interface between the V2X UE and the V2X application server in the V2X application specific layer.

The functions of the V2X UE and the V2X application server that may have such a hierarchical structure in embodiments of the technology according to the present disclosure will be described in detail later.

As understood from FIG. 2, at an application level, V2X communication is treated as end-to-end communication between the V2X UE and the V2X application server, and content of the V2X communication is transparent to base stations and other network nodes along the communication path.

Section 7 of 3GPP TS 23.286 v17.3.0 describes various deployment models for V2X application specific servers and VAE servers. The V2X application specific server and the VAE server may be physically co-located in a single apparatus, or may be located in separate apparatuses. Each of these servers may belong to either the domain of a V2X service provider or the domain of a network operator.

### 2. Embodiment of V2X Communication System

### <2-1. Outline of System>

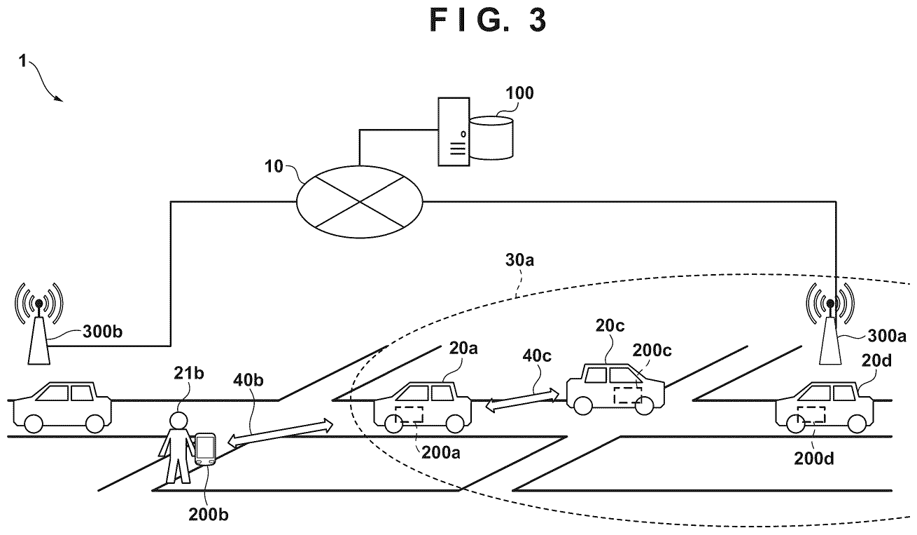

FIG. 3 is a schematic diagram illustrating an example of a configuration of a V2X communication system 1 according to an embodiment. Referring to FIG. 3, the V2X communication system 1 includes a server apparatus 100, UEs 200a, 200b, 200c, and 200d, and base stations 300a and 300b.

Note that, in the following description, in a case where it is not necessary to distinguish the UEs 200a, 200b, 200c, and 200d from each other, they are collectively referred to as the UE 200 by omitting the character at the end of the reference numeral. The same applies to the base stations 300a and 300b (base station 300) and other components.

The server apparatus 100 is a V2X application server that provides a V2X service for the purpose of improving road safety. The server apparatus 100 is connected to a plurality of base stations including the base stations 300a and 300b via a network 10. The network 10 may be, for example, a 5G core network or a combination of a 5G core network and an IP network.

The UE 200 is a terminal apparatus that uses the V2X service provided by the server apparatus 100. In the example of FIG. 3, the UE 200a is an in-vehicle terminal mounted on a vehicle 20a, the UE 200c is an in-vehicle terminal mounted on a vehicle 20c, and the UE 200d is an in-vehicle terminal mounted on a vehicle 20d. The UE 200b is a pedestrian terminal carried by a pedestrian 21b. For example, the UE 200a located in a cell 30a can establish a radio link with the base station 300a to receive downlink data from the base station 300a and transmit uplink data to the base station 300a. In addition, the UE 200a can perform communication with other V2X UEs existing in the vicinity via the sidelink under the assistance (e.g., scheduling of resources or pre-assignment of resource pools) of the base station 300a. For example, FIG. 3 illustrates a sidelink 40b between the UE 200a and the UE 200b and a sidelink 40c between the UE 200a and the UE 200c. Of course, UEs 200 other than the UE 200a can also communicate with neighboring V2X UEs via a sidelink.

The base station 300 may be, for example, a gNB or an ng-eNB, and relays communication between the UE 200 and the server apparatus 100. In the example of FIG. 3, the base station 300a serves UEs 200 in the cell 30a, and the base station 300b serves UEs 200 in a cell different from the cell 30a. Broadcasting of information from the base station 300 to a plurality of UEs 200 in a cell is performed on a physical broadcast channel (PBCH). Transmission of downlink data from the base station 300 to a particular UE 200 is performed on a physical downlink shared channel (PDSCH). Transmission of uplink data from a particular UE 200 to the base station 300 is performed on a physical uplink shared channel (PUSCH). Control signaling for controlling the data transmission (e.g., downlink assignment, scheduling request, uplink grant, retransmission control, and the like) is performed on various control channels including a physical downlink control channel (PDCCH) and a physical uplink control channel (PUCCH).

In the present embodiment, it is assumed that at least some UEs 200 can, in a case where a threat related to road safety is detected, transmit an alarm message notifying of the presence of the threat on the sidelink. The UE 200 may detect a safety threat using any known method. For example, the UE 200 mounted on a vehicle may recognize one or more of the following as threats:
Speed or acceleration of self-vehicle or other vehicle exceeding reference value
Deviation of self-vehicle or other vehicle from correct lane of travel
Physiological abnormality of driver of self-vehicle
Detection of alcohol component from exhalation of driver of self-vehicle
Detection of contact or collision
Abnormal driving environment (e.g., presence of fallen object or decrease in road surface temperature)

The UE 200 that has detected such a safety threat transmits an alarm message on, for example, a sidelink shared channel (SL-SCH). The alarm message may include type information indicating a type of the detected threat. The server apparatus 100 configures each UE 200 to receive an alarm message transmitted from another UE 200 via the sidelink. When the UE 200 that receives an alarm message alerts the user via a user interface, the user can recognize the threat early and take an appropriate action to ensure safety.

However, an alarm message sent via a sidelink can be received by UEs 200 located within a communication range of the sidelink. According to the results of evaluation experiment disclosed by “Cellular-V2X Technology Overview”, a radius of a sidelink communication range is 1,000 meters at the maximum in a situation in which a line of sight is maintained and 400 meters at the maximum in a situation in which there is an obstacle between vehicles. For example, in the situation illustrated in FIG. 3, assume that the UE 200c of the vehicle 20c has detected that the vehicle 20d is traveling at a speed exceeding a reference value and issued an alarm message. The UE 200a of the vehicle 20a receives the alarm message via the sidelink 40c. Meanwhile, the UE 200b cannot receive the alarm message sent from the UE 200c due to the long distance to the UE 200c or an obstacle existing between the UE 200b and the UE 200c. Accordingly, the UE 200b does not alert the pedestrian 21b, who is a user, of the threat about the vehicle 20d, and thus the pedestrian 21b will be exposed to a danger. In the present embodiment, in order to eliminate or alleviate such inconveniences, the V2X communication system 1 introduces a mechanism that substantially extends a reachable range of an alarm message by causing a UE 200 that has received the alarm message to relay the received message.

### <2-2. Configuration Example of Server Apparatus>

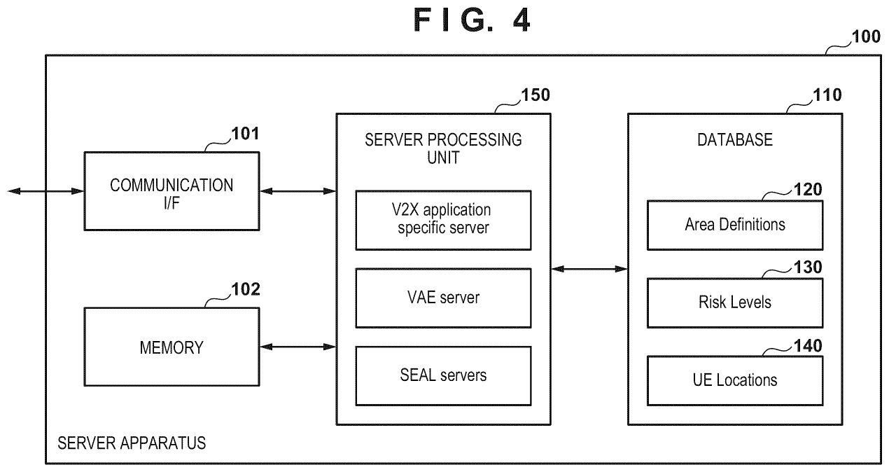

FIG. 4 is a block diagram illustrating an example of a configuration of the server apparatus 100 according to the present embodiment. Referring to FIG. 4, the server apparatus 100 includes a communication interface (I/F) 101, a memory 102, a database 110, and a server processing unit 150.

The communication I/F 101 is a communication unit for the server apparatus 100 to communicate with one or more UEs 200 operating as clients of the V2X application. The communication I/F 101 is connected to the network 10, and can communicate with the UE 200 connected to the base station 300 via one or more network nodes in the network 10 and the base station 300.

The memory 102 may include any combination of a nonvolatile storage medium such as a read only memory (ROM) and a volatile storage medium such as a random access memory (RAM). For example, the ROM prestores computer programs for several server modules described below. The RAM provides a temporary storage area for computation by the server processing unit 150.

The database 110 is a database that stores various data required for providing the V2X application by the server apparatus 100. In the present embodiment, the database 110 includes area definition data 120, risk level data 130, and UE location data 140. Note that although an example in which the server apparatus 100 includes the database 110 will be described here, the database 110 may be implemented in an apparatus (e.g., database server or cloud server) separate from the server apparatus 100 as long as it can be accessed by the server processing unit 150.

The area definition data 120 is data indicating definitions of a plurality of geographical areas for the V2X application provided by the server apparatus 100. The area definition data 120 may include, for example, for each geographical area, the following four data items:
“Area ID”
“Area definition”
“Associated base station”
“Neighboring area”

The “area ID” is an identifier for uniquely identifying each geographical area. The “area definition” is a set of parameters that define the geographic location and shape of each geographical area. For example, for a polygonal geographical area, the “area definition” indicates a set of coordinate values (e.g., latitude and longitude) of N (N is integer greater than or equal to three) vertices. For a circular geographical area, the “area definition” indicates the coordinate values of the center point and the radius. The “associated base station” indicates at least one address (or other identification information) for communication with a base station serving each geographical area. The “neighboring area” is data indicating a neighbor relationship between geographical areas. For example, in a case where second and third geographical areas are neighbors of a first geographical area, the “neighboring area” of the record of the first geographical area may indicate a list of area IDs of the second and third geographical areas.

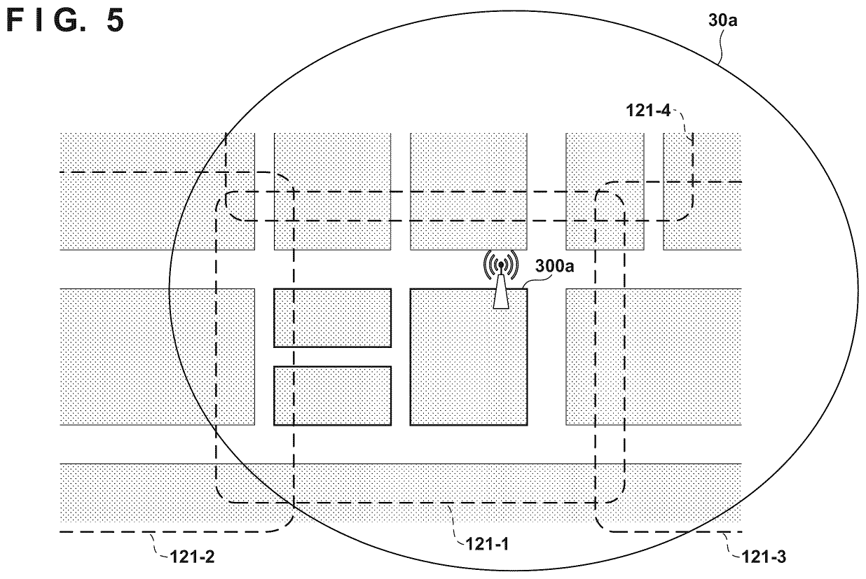

FIG. 5 is an explanatory diagram for describing an example of a definition of a geographical area. Referring to FIG. 5, boundary lines of four geographical areas 121-1, 121-2, 121-3, and 121-4 are indicated by broken lines in a manner superimposed on a road map of an area where the base station 300a is installed. Here, the shape of these geographical areas is substantially rectangular. The geographical areas 121-2, 121-3, and 121-4 are neighboring areas of the geographical area 121-1. Therefore, in this case, the area definition data 120 may include a record that associates “area ID” identifying the geographical area 121-1 with a list of respective area IDs of the geographical areas 121-2, 121-3 and 121-4 as “neighboring area”. Neighboring two geographical areas may partially overlap with each other. FIG. 5 also illustrates a boundary line of the cell 30a of the base station 300a. The geographical area is typically defined in view of the purpose of the V2X application, independent of coverages of cells. For example, in the present embodiment, an area may be divided into a plurality of geographical areas on the basis of differences in characteristics of radio communication environments (e.g., density of obstacles such as buildings, noise level, and the like), road characteristics (e.g., speed limit, number of lanes, and the like) or traffic trends (e.g., amount of pedestrians, frequency of occurrence of traffic congestion, and the like.).

The risk level data 130 is data indicating a risk level determined for each of the plurality of geographical areas defined by the area definition data 120. The risk level data 130 may include, for example, the following three data items:
“Management area”
“Risk level”
“Last-updated-at”

The “management area” identifies each of the geographical areas subject to the risk level management by an “area ID” registered in the area definition data 120. The “risk level” is a parameter indicating a risk level determined for the geographical area identified by the “management area”. In the present embodiment, the “risk level” is evaluated in three levels, and indicates any value of “low” meaning that the risk level is the lowest, “medium” meaning that the risk level is medium, and “high” meaning that the risk level is the highest. Note that in another embodiment, the “risk level” may be evaluated in two or four or more levels. The “last-updated-at” indicates the date and time when the value of the “risk level” was last updated for each geographical area.

The UE location data 140 is data for managing locations of the V2X UEs that utilize the V2X application provided by the server apparatus 100. The UE location data 140 may include, for example, the following four data items:
“UE ID”
“Location”
“Camping area”
“Last-reported-at”

The “UE ID” is an identifier for uniquely identifying each V2X UE. The “location” indicates the location reported last from each V2X UE. The “camping area” identifies the geographical area corresponding to the location reported last from each V2X UE by an “area ID” registered in the area definition data 120. The “last-reported-at” indicates the date and time when the location was last reported from each V2X UE.

Note that the configuration of the database 110 is not limited to the configuration described here. The database 110 may store additional data, and some data items described above may be omitted. For example, the database 110 may store a user ID and authentication information (e.g., password, authentication key, or the like) for authenticating a user who uses the V2X application provided by the server apparatus 100.

The server processing unit 150 is a functional module that operates as a server of the V2X application. The function of the server processing unit 150 can be implemented by one or more processors (e.g., central processing units (CPUs)) executing computer programs stored in the memory 102. As illustrated in FIG. 4, the server processing unit 150 includes three types of server modules of a V2X application specific server, a VAE server, and SEAL servers. The functional split between these server modules may be as described with reference to FIG. 2.

When the UE 200 operating as a client of the V2X application connects to a base station 300, the server processing unit 150 sets up a communication link (V1-APP/V1-AE/SEAL-UU) for V2X communication with the UE 200 after performing an authentication procedure as necessary.

In addition, the server processing unit 150 configures each UE 200 to receive an alarm message regarding road safety sent from another V2X UE via the sidelink. For example, in a case where alarm messages are broadcast on the PC5 interface, the server processing unit 150 configures the UE 200 to monitor for messages having a destination layer 2 ID for broadcast reception on the sidelink resource. In a case where alarm messages are groupcast on the PC5 interface, the server processing unit 150 assigns a group ID for alarm message reception to the UE 200, and configures the UE 200 to monitor for messages having a destination layer 2 ID corresponding to the group ID on the sidelink resource. The group ID may be different for each geographical area, may be common across a plurality of geographical areas, or may be common for the entire system. Alarm messages may be transmitted by unicast, but in terms of quick transmission of the alarm messages, broadcast or groupcast is more advantageous than unicast that requires establishment of a separate PC5 interface.

In addition, the server processing unit 150 manages the risk level of each geographical area indicated by the risk level data 130. For example, the initial value of the “risk level” of the risk level data 130 is determined in advance on the basis of static conditions such as the characteristics of the radio communication environment and the road characteristics in the corresponding geographical area. The server processing unit 150 may update the value of the “risk level” on the basis of a temporal condition or a sunlight condition that may include a season or a time zone (e.g., increase risk level by one level in the evening when visibility is deteriorating). Furthermore, in the present embodiment, the server processing unit 150 updates the value of the “risk level” of the risk level data 130 on the basis of the V2X message received from one or more terminal apparatuses via the communication I/F 101. Each of the terminal apparatuses here may be the UE 200 described with reference to FIG. 3, or may be another type of terminal apparatus (e.g., roadside unit with sensor or camera). For example, in a case where it is determined that the following event has occurred in a certain geographical area on the basis of a V2X message received from a terminal apparatus, the server processing unit 150 may temporarily increase the value of the “risk level” of the geographical area until it is determined that the event has been resolved:
Presence of vehicle satisfying above-described threat detection condition
Vehicle stopping on road
Traffic congestion
Abnormality in driving environment

The server processing unit 150 also tracks the location of the connected UE 200. Specifically, the server processing unit 150 periodically receives location information of the UE 200 via the communication I/F 101 from the connected UE 200. The server processing unit 150 then determines in which geographical area the UE 200 is located on the basis of the received location information, and updates the “location”, “camping area”, and “last-reported-at” of the corresponding record of the UE location data 140. The location information may indicate positional coordinates of a geographical location acquired as a result of positioning in the UE 200 as the location of the UE 200. In this case, the server processing unit 150 can determine to which geographical area the geographical position indicated by the location information belongs on the basis of the “area definition” of the area definition data 120. When the size of the geographical area is equal to or larger than the size of the cell served by the base station 300, the location information may indicate the cell ID of the cell to which the UE 200 is connected as the location. In this case, the server processing unit 150 can determine to which geographical area the cell to which the UE 200 is connected belongs, on the basis of known mapping between the cell ID indicated by the location information and an area ID of the corresponding geographical area.

In the present embodiment, in a case where the area definition data 120 indicates that the first and second geographical areas are neighboring areas, the server processing unit 150 instructs a UE 200 located in the first geographical area to relay, via a sidelink, a received alarm message so that the alarm message sent in the first geographical area can also be received in the second geographical area.

In a first embodiment example, the relay instruction is performed by transmitting, in response to determining that a UE 200 is located in the first geographical area, a control message via the communication I/F 101 to the UE 200 that instructs to relay, via the sidelink, an alarm message received in the first geographical area. That is, in the first embodiment example, the relay instruction is performed at the application level. The server processing unit 150 may transmit the control message to the UE 200 when it is determined that the UE 200 is located in the first geographical area and located in the second geographical area or near the second geographical area. The UE 200 that has received such a control message relays the alarm message, thereby the reachable range of the alarm message is substantially extended and another UE 200 located in the second geographical area neighboring the first geographical area will be able to receive the relayed alarm message.

In a second embodiment example, in a case where the first and second geographical areas are neighboring areas, the server processing unit 150 transmits, to the base station 300 serving the first geographical area via the communication I/F 101, a request message requesting to broadcast control information indicating that a V2X UE located in the first geographical area and located in the second geographical area or near the second geographical area should relay an alarm message. That is, in the second embodiment example, the relay instruction is performed not at the application level but at the radio link level. Upon receiving this request message from the server apparatus 100, the base station 300 includes control information for instructing to relay an alarm message in a system information block (SIB) to broadcast the control information over the PBCH, for example.

The server processing unit 150 may determine that the alarm message received in the neighboring first geographical area should become receivable also in the second geographical area in a case where a risk level of the second geographical area indicated by the risk level data 130 satisfies a predetermined criterion. The predetermined criterion may include that the risk level is equal to or higher than a predefined threshold (for example, it is equal to “high”, or to “high” or “medium”). For example, assume that, among the three neighboring areas 121-2, 121-3 and 121-4 neighboring the geographical area 121-1 illustrated in FIG. 5, the risk level of the neighboring area 121-4 is “high” (for example, because of no separate sidewalk beside the road and so on) while the risk levels of the neighboring areas 121-2 and 121-3 are “low”. In this case, the server processing unit 150 issues an instruction to relay an alarm message only to UEs 200 of which positions are within or near the neighboring area 121-4 out of UEs 200 located in the geographical area 121-1. Such relay control allows a reachable range of alarm messages to be selectively extended in a specific direction.

The server processing unit 150 may determine that the alarm message received in the first geographical area should become receivable also in the second geographical area in a case where not only a risk level of the second geographical area but also a risk level of the first geographical area satisfy the above-described predetermined criterion. For example, assume that, among the four geographical areas illustrated in FIG. 5, the risk levels of the geographical areas 121-1 and 121-4 are “high” while the risk levels of the geographical areas 121-2 and 121-3 are “low”. In this case, the server processing unit 150 instructs UEs 200 located near a boundary between the geographical area 121-1 and the geographical area 121-4 to relay an alarm message while it does not instruct UEs 200 located near a boundary between the geographical area 121-1 and the geographical area 121-2 or 121-3 to relay an alarm message. Such relay control allows only a reachable range of alarm messages that occur in an area having a relatively high risk level to be selectively extended.

FIG. 6A illustrates a first example of a format of a control message transmitted to a UE 200 for a relay instruction. In the first example, a format 160a includes a V2X UE ID 161, a camping area 162, and a relay flag 163. The V2X UE ID 161 indicates a UE ID for identifying the UE 200 that is the destination of the control message. The camping area 162 indicates an area ID for identifying a geographical area in which it is determined that the UE 200 identified by the V2X UE ID 161 is located. The relay flag 163 is a control parameter indicating whether a UE 200 identified by the V2X UE ID 161 should relay an alarm message. For example, a value “0” of the relay flag 163 indicates that the UE 200 having received this control message should not relay an alarm message, and a value “1” of the relay flag 163 indicates that the UE 200 having received this control message should relay an alarm message.

FIG. 6B illustrates a second example of a format of a control message transmitted to a UE 200 for a relay instruction. In the second example, a format 160b includes the V2X UE ID 161 and the relay flag 163.

FIG. 6C illustrates a third example of a format of a control message transmitted to a UE 200 for a relay instruction. In the third example, a format 160c includes the V2X UE ID 161, the camping area 162 and a neighboring area 164. The neighboring area 164 indicates one or more geographical areas that are near the position of the UE 200 identified by the V2X UE ID 161 out of the geographical areas neighboring the geographical area identified by the camping area 162. The format 160c may be used in combination with a format 160d described next since the format 160c does not indicate whether a UE 200 having received this control message should relay an alarm message.

FIG. 6D illustrates a fourth example of a format of a control message transmitted to a UE 200 for a relay instruction. In the fourth example, a format 160d includes the number of areas 165 and K pairs of an area ID 166-k and a relay area list 167-k (k=1, 2, . . . , K). The number of areas 165 indicates the number K of pairs of the area ID and the relay area list included in the control message. The area ID 166-k indicates an area ID for identifying a k-th geographical area. The relay area list 167-k indicates a list of area IDs that identify geographical areas to which an alarm message is to be relayed from the k-th geographical area. Upon receiving both the control messages in the formats 160c and 160d, the UE 200 looks up, in the K area IDs 166-k of the control message in the format 160d, the area ID indicated by the camping area 162 of the control message in the format 160c, and can recognize that it is instructed to relay an alarm message in a case where the relay area list 167-k paired with the matched area ID 166-k includes any area ID indicated by the neighboring area 164 of the control message in the format 160c.

In the first embodiment example described above, the control message that the server processing unit 150 can transmit to the UE 200 may be any of the following options:
Message A (format 160a)
Message B (format 160b)
Message C (format 160c) and message D (format 160d)

The message A, the message B, or the message C may be transmitted each time the location of the UE 200 changes. On the other hand, after being transmitted to the UE 200 once, the message D need not be transmitted to the same UE 200 again unless the risk level of one or more geographical areas changes. Each message may of course include additional control parameters not illustrated. If the UE 200 can autonomously determine the geographical area in which it is currently located and neighboring areas thereof on the basis of the location of the UE 200 (e.g., by referring to area definition downloaded in advance), then it is possible to transmit only the message D (format 160d) to the UE 200.

In the second embodiment example described above, the control information that can be received by the UE 200 may be any of the following options:
System information (format 160d) broadcast from base station and message C (format 160c) received from server apparatus 100
System information (format 160d) broadcast from base station

The second option may be adopted when the UE 200 can autonomously determine the geographical area in which it is currently located and neighboring area thereof on the basis of the location of the UE 200. The system information broadcasting from the base station may be performed by including the system information in a system information block provided for controlling the V2X communication, for example.

It should be noted in the first embodiment example that, in a case where there exist a plurality of UEs 200 near a boundary between the first and second geographical areas, the server processing unit 150 may instruct only a subset of the plurality of UEs 200 to relay an alarm message. The server processing unit 150 may determine which UEs 200 should relay an alarm message by taking one or more of capability, location, processing performance, and a remaining amount of electric power of each UE 200 into consideration. For example, by issuing a relay instruction only to a UE 200 with the highest processing performance out of the UEs 200 located close to each other, it is possible to effectively extend the reachable range of the alarm message while avoiding message collisions due to multiple UEs 200 relaying the alarm message.

### <2-3. Configuration Example of Terminal Apparatus>

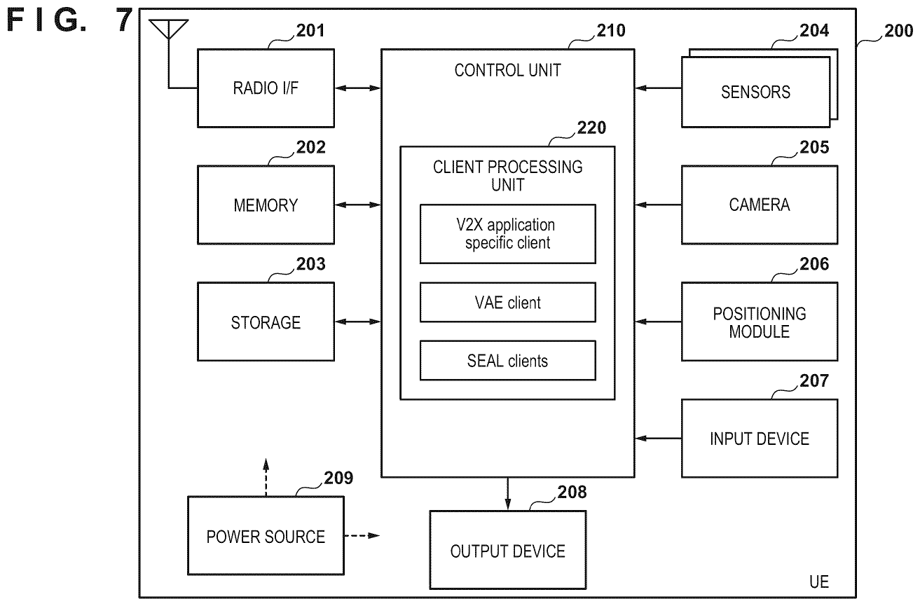

FIG. 7 is a block diagram illustrating an example of a configuration of the UE 200 according to the present embodiment. Referring to FIG. 7, the UE 200 includes a radio I/F 201, a memory 202, a storage 203, sensors 204, a camera 205, a positioning module 206, an input device 207, an output device 208, a power source 209, and a control unit 210.

The radio I/F 201 is a radio communication unit for the UE 200 to perform radio communication. In the present embodiment, the radio I/F 201 can communicate via a radio link established with the base station 300, and can further communicate with another V2X UE via a sidelink.

The memory 202 may include any combination of a nonvolatile storage medium such as a ROM and a volatile storage medium such as a RAM. For example, the ROM prestores computer programs for several client modules running in the control unit 210. The RAM provides a temporary storage area for computation by the control unit 210.

The storage 203 is a storage device for storing large-scale data. The storage 203 may be, for example, a hard disk drive (HDD) or a solid state drive (SSD).

The sensors 204 are a set of various sensors mounted on the UE 200. In a case where the UE 200 is a pedestrian terminal, the sensors 204 may include an acceleration sensor, a gyro sensor, and an orientation sensor. In a case where the UE 200 is an in-vehicle terminal, the sensors 204 may further include sensors such as a distance measuring sensor (e.g., LiDAR or millimeter wave radar) and a biological information sensor in addition to the sensors described above.

The camera 205 is an imaging module capable of imaging the situation around the UE 200. The sensors 204 and the camera 205 may be used to detect a threat related to road safety according to the above-described threat detection condition.

The positioning module 206 is a module for measuring the position of the UE 200. The positioning module 206 may be capable of acquiring the latitude, longitude, and altitude of the current position of the UE 200 using, for example, a global navigation satellite system (GNSS) represented by a global positioning system (GPS). Alternatively or additionally, the positioning module 206 may be capable of estimating the current position of the UE 200 on the basis of a known absolute position of the connected base station and a relative position from the base station.

The input device 207 is a device for the UE 200 to receive an instruction and information input from the user. The input device 207 includes, for example, one or more of a touch sensor, a button, a switch, a keypad, and a microphone.

The output device 208 is a device for the UE 200 to output information or a signal to the user. The output device 208 includes, for example, one or more of a display, a speaker, a light, and a vibrator.

The power source 209 is a rechargeable battery for supplying power to each unit of the UE 200 via a power line partially illustrated in FIG. 7. The supply of power from the power source 209 is controlled by the control unit 210.

The control unit 210 includes one or more processors, and controls the overall functions of the UE 200 by executing a computer program stored in the memory 202. For example, the control unit 210 functions as a client processing unit 220 that operates as a client of the V2X application. The client processing unit 220 includes three types of client modules: a V2X application specific client, a VAE client, and SEAL clients. The functional split between these client modules may be as described with reference to FIG. 2. The control unit 210 may also have various other functions of a general pedestrian terminal or an in-vehicle terminal, but here, for the sake of simplicity of description, the functions of the client processing unit 220 will be mainly described.

The client processing unit 220 connects to the server apparatus that operates as a server of the V2X application via the radio link between the radio I/F 201 and the base station 300. The client processing unit 220 sets up the radio I/F 201 to receive, via the sidelink, an alarm message regarding road safety sent from another V2X UE in accordance with a configuration signaled from the server processing unit 150 of the server apparatus 100. For example, the radio I/F 201 monitors sidelink resources for a message having a destination layer 2 ID for the alarm message, and receive such an alarm message when the alarm message has been sent from a nearby V2X UE. In a case where the alarm message is received via the sidelink, the client processing unit 220 alerts the user via the user interface of the UE 200 so that the user can take an appropriate action for ensuring safety. For example, the alert may be made to the user by displaying a warning text or icon on the display of the output device 208, outputting a warning sound or a warning voice from the speaker, or ringing the vibrator.

The client processing unit 220 may be capable of detecting a safety threat according to one or more of the above-described threat detection conditions on the basis of sensor data input from the sensors 204 or video data input from the camera 205. In a case where a safety threat is detected, the client processing unit 220 alerts the user and causes the radio I/F 201 to transmit an alarm message on a sidelink communication resource. As described above, the alert message may be transmitted in any of broadcast, groupcast, or unicast. Note that it is not necessary for the client processing units 220 of all the UE 200 to have the function of transmitting the alarm message.

The client processing unit 220 periodically reports location information indicating the latest location of the UE 200 acquired by the positioning module 206 to the server apparatus 100. The V2X message for reporting the location information is transmitted to the server apparatus 100 via the radio I/F 201 and the base station 300 to which it is connected. As described above, the server processing unit 150 of the server apparatus 100 determines in which geographical area the UE 200 is located according to the report of the location information. The V2X message transmitted to the server apparatus 100 may include information for updating the risk level for each geographical area managed by the server processing unit 150. For example, the client processing unit 220 may transmit sensor data input from the sensors 204 to the server apparatus 100. Furthermore, the client processing unit 220 may notify the server apparatus 100 that a safety threat has been detected in accordance with any of the threat detection conditions. Furthermore, the client processing unit 220 may perform more advanced processing such as determination of a stopped vehicle, determination of traffic congestion, or determination of abnormality of a travel environment, and notify the server apparatus 100 of the determination result.

In the present embodiment, the instruction related to relaying an alarm message received from another V2X UE via the sidelink is received by the client processing unit 220 at the application level directly from the server apparatus 100 or indirectly at the radio link level.

For example, assume that the location information of the UE 200 reported to the server apparatus 100 indicates a position in the first geographical area and in the second geographical area or near the second geographical area. In this case, the client processing unit 220 may receive an instruction to relay, via the sidelink, an alarm message received from another V2X UE. Alternatively, such an instruction may be received in a case where the risk level data 130 indicates that the risk level of the second geographical area is high (or the risk levels of both the first and second geographical areas are high). When the instruction to relay an alarm message is received, the client processing unit 220 causes the radio I/F 201 to relay, via the sidelink, an alarm message received in the first geographical area from another V2X UE. This makes it possible for a V2X UE located in the second geographical area neighboring the first geographical area to receive the relayed alarm message.

In the first embodiment example, the instruction related to relaying an alarm message is included in a control message received from the server apparatus 100 via the radio link of the radio I/F 201 as a response to the transmission of the location information. For example, when it is determined that the UE 200 is located in a place where an alarm message is required to be relayed, the control message mentioned above includes a control parameter that instructs to relay an alarm message (for example, the relay flag 163 indicating the value “1”). Meanwhile, when it is determined that the UE 200 is located in a place where an alarm message is not required to be relayed, the control message mentioned above includes a control parameter indicating that an alarm message does not need to be relayed (for example, the relay flag 163 indicating the value “0”).

In the second embodiment example, the instruction related to relaying an alarm message is included in control information broadcast from the base station 300 serving the geographical area in which the UE 200 is located and received by the radio I/F 201. For example, in a case where it is required to relay an alarm message in the vicinity of the boundary between the first geographical area and the second geographical area, the control information broadcast from the base station 300 includes an association between the area IDs of the first and second geographical areas (for example, a combination of the area ID 166-k and the relay area list 167-k). The client processing unit 220 may monitor system information blocks for controlling V2X communication (for example, SIB13 and SIB14) periodically broadcast from the base station 300 to obtain the control information including such an instruction related to relaying an alarm message, for example. The client processing unit 220 may receive a control message including an area ID of the geographical area in which the UE 200 is located from the server apparatus 100, or may autonomously determine in which geographical area the UE 200 is located.

The control message or the control information that can be received by the UE 200 in the first embodiment example and the second embodiment example may have the format described above with reference to FIGS. 6A to 6D.

It should be noted that, in the present embodiment, the alarm message transmitted and received via the sidelink may include a control parameter for distinguishing between an original alarm message transmitted by a V2X UE that has detected a threat and an alarm message that has been relayed at least once. The control parameter may be a flag indicating a value that is different for the original alarm message and the relayed alarm message, or may be a counter indicating how many times it has been relayed, for example. Then, the client processing unit 220 may refrain from relaying the alarm message in which this control parameter indicates that the message has been relayed at least once irrespective of an instruction from the server apparatus 100. This makes it possible to prevent message congestion or an excessive extension of the reachable range from occurring due to an alarm message relayed over several hops.

### <2-4. Configuration Example of Base Station>

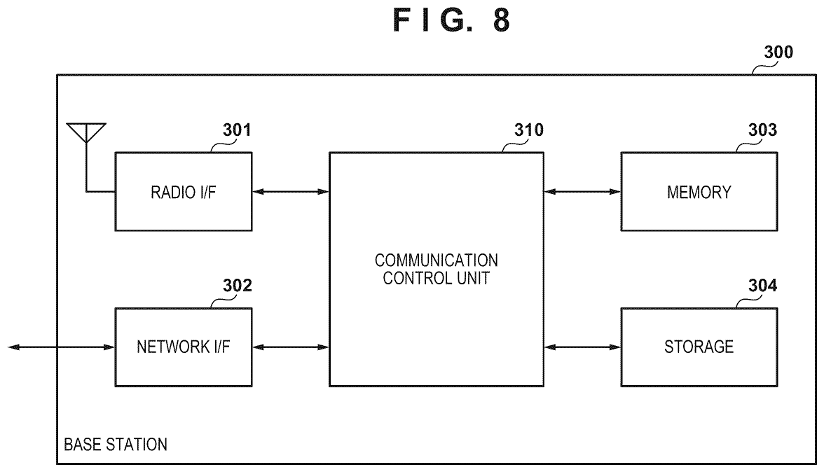

FIG. 8 is a block diagram illustrating an example of a configuration of the base station 300 according to the present embodiment. Referring to FIG. 8, the base station 300 includes a radio I/F 301, a network I/F 302, a memory 303, a storage 304, and a communication control unit 310.

The radio I/F 301 is a radio communication unit for the base station 300 to provide radio access to one or more UEs 200 in a cell 30. For example, when the coverage of the cell 30 of the base station 300 includes a first geographical area, the base station 300 can wirelessly communicate at least with the UE 200 located in the first geographical area via the radio I/F 301.

The network I/F 302 is a network communication unit for the base station 300 to communicate with a network node in the network 10 and other apparatuses connected to the network 10. The base station 300 can communicate with the server apparatus 100 via the network I/F 302, for example.

The memory 303 may include any combination of a nonvolatile storage medium such as a ROM and a volatile storage medium such as a RAM. For example, the ROM stores in advance a computer program executed by the communication control unit 310. The RAM provides a temporary storage area for computation by the communication control unit 310. The storage 304 is a storage device for storing large-scale data. The storage 304 may be, for example, an HDD or an SSD.

The communication control unit 310 includes one or more processors, and executes a computer program stored in the memory 303 to control radio communication performed by the radio I/F 301 and network communication performed by the network I/F 302. For example, when a connection request from the UE 200 is received by the radio I/F 301, the communication control unit 310 establishes a radio link between the UE 200 and the radio I/F 301. In addition, when the UE 200 uses the V2X application provided by the server apparatus 100, the communication control unit 310 mediates communication at the application level between the UE 200 and the server apparatus 100. Further, the communication control unit 310 schedules a resource of the sidelink or assigns a resource pool for the sidelink for the UE 200 which is a V2X UE. This enables the UE 200 to perform radio communication via a radio link with the base station 300 and a sidelink with another V2X UE.

In an embodiment example, the communication control unit 310 is involved in controlling relaying of alarm messages by the UEs 200. For example, in a case where the first geographical area and the second geographical area are neighboring areas and it is determined that the risk level of the second geographical area (or the risk levels of both the first and second geographical areas) satisfies the predetermined criterion, the server apparatus 100 transmits, to the base station 300, a request message requesting to broadcast control information indicating that a UE 200 located near the boundary between these two geographical areas should relay, via the sidelink, an alarm message received from another V2X UE. When this request message is received via the network I/F 302, the communication control unit 310 causes the radio I/F 301 to broadcast the control information indicating that a UE 200 located near the boundary should relay an alarm message via the sidelink. The format of the broadcasted control information may be the format described above with reference to the second embodiment example. The radio I/F 301 may include the control information in a system information block for controlling V2X communication and broadcast the control information. In this case, a terminal apparatus not involved in V2X communication can ignore the system information block.

### 3. Flow of Processing

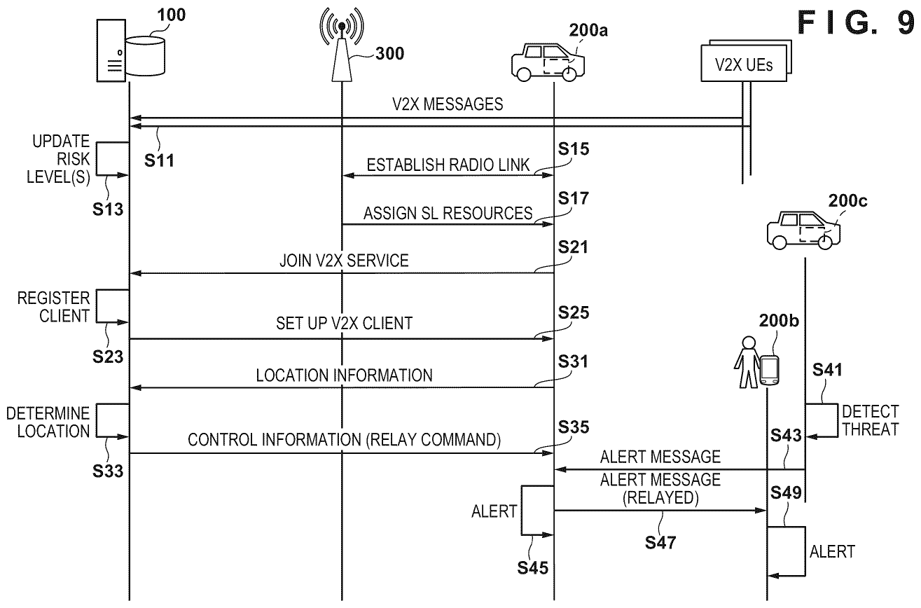

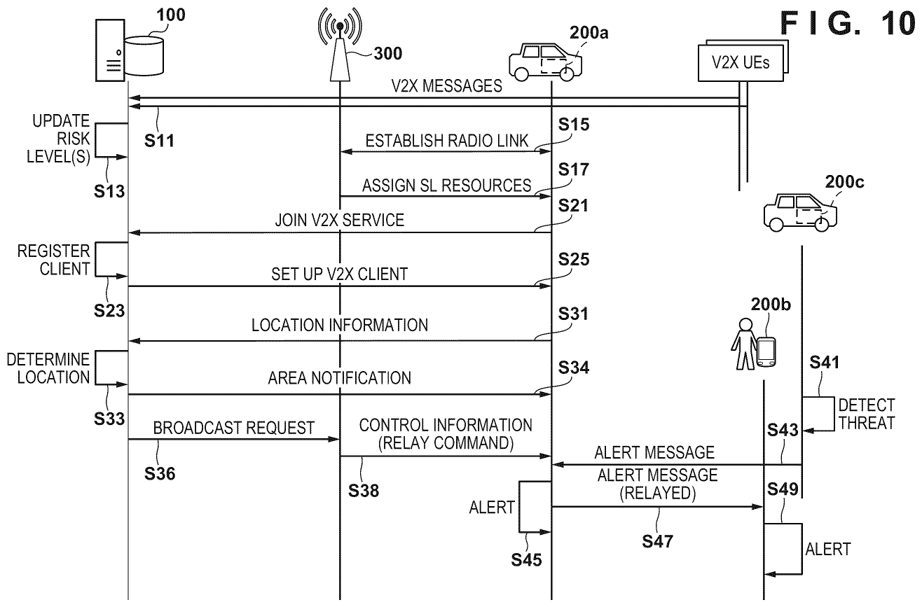

In this section, an example of a flow of processing that can be executed in the above-described V2X communication system 1 will be described with reference to sequence diagrams of FIGS. 9 and 10. Note that in the following description, a processing step is abbreviated as S (step).

### <3-1. First Embodiment Example>

FIG. 9 is a sequence diagram illustrating an example of a flow of processing according to the first embodiment example. The illustrated processing mainly involves the server apparatus 100, the UE 200a, the UE 200b, the UE 200c, and the base station 300. Note, however, that a plurality of V2X UEs other than the UEs 200a to 200c also perform V2X message exchange with the server apparatus 100.

First, in S11, the server apparatus 100 receives V2X messages from a plurality of V2X UEs. Each received V2X message may include any information, such as, for example, the speed or acceleration of a traveling vehicle, a location on a road, physiological parameters of the driver, or the state of the traveling environment. In S13, the server processing unit 150 of the server apparatus 100 updates the risk level of each geographical area indicated by the risk level data 130 on the basis of the received V2X messages. Such updating can be performed periodically or intermittently while the server apparatus 100 is operating.

Then, when the UE 200a enters coverage of the cell 30 served by the base station 300, in S15, a radio link between the UE 200a and the base station 300 is established. Next, in S17, the communication control unit 310 of the base station 300 schedules a resource of the sidelink or assigns a resource pool for the sidelink for the UE 200a which is a V2X UE.

Next, in S21, the client processing unit 220 of the UE 200a accesses the server apparatus 100 using a URL of the server apparatus 100 stored in advance in the memory 202, for example, and participates in the V2X service provided by the server apparatus 100. In S23, the server processing unit 150 of the server apparatus 100 registers the UE 200a as a connected client (when authentication of UE 200a is successful). Then, in S25, the server processing unit 150 sets up a communication link with the UE 200a. For example, the client processing unit 220 of the UE 200a sets up the radio I/F 201 to receive, via the sidelink, an alarm message sent from another V2X UE in accordance with a configuration from the server processing unit 150.

Next, in S31, the client processing unit 220 of the UE 200a transmits location information indicating the latest location of the UE 200a to the server apparatus 100. In S33, the server processing unit 150 of the server apparatus 100 that has received the location information determines whether the UE 200a is located in a place where it should relay an alarm message over the sidelink. Here, it is assumed that the UE 200a is determined to be located in the place where it should relay an alarm message because it is located near the boundary between the first and second geographical areas for which the risk level data 130 indicates a high risk level. In S35, the server processing unit 150 transmits, to the UE 200a, a control message indicating that an alarm message should be relayed via the sidelink when the alarm message is received via the sidelink. The client processing unit 220 of the UE 200a receives this control message via the radio I/F 201.

Thereafter, in S41, the UE 200c, which takes part in the same V2X service, detects a threat related to road safety. In S43, the client processing unit 220 of the UE 200c transmits (e.g., broadcast or groupcast) an alarm message over a communication resource of the sidelink. The radio I/F 201 of the UE 200a continuously monitors broadcast or groupcast resources of the sidelink, and receives the alarm message sent from the UE 200c. Meanwhile, although the UE 200b also continuously monitors broadcast or groupcast resources of the sidelink, the UE 200b does not receive the alarm message at this point because it is located outside the reachable range of the alarm message from the UE 200c. In S45, in response to the reception of the alarm message, the client processing unit 220 of the UE 200a alerts the user via the user interface so that the user can take an appropriate action for ensuring safety.

As the client processing unit 220 of the UE 200a has received the instruction to relay an alarm message in S35, it relays, over a communication resource of the sidelink, the alarm message received from the UE 200c. The radio I/F 201 of the UE 200b receives the alarm message sent (relayed) from the UE 200c at this point. Then, in S49, in response to the reception of the relayed alarm message, the client processing unit 220 of the UE 200b alerts the user via the user interface so that the user can take an appropriate action for ensuring safety.

### <3-2. Second Embodiment Example>

FIG. 10 is a sequence diagram illustrating an example of a flow of processing according to the second embodiment example. The illustrated processing mainly involves the server apparatus 100, the UE 200a, the UE 200b, the UE 200c, and the base station 300. Note, however, that a plurality of V2X UEs other than the UEs 200a to 200c also perform V2X message exchange with the server apparatus 100.

The processing steps of S11 to S33 may be similar to the corresponding processing steps in the first embodiment example described with reference to FIG. 9. Therefore, descriptions of these processing steps are omitted here.

After determining the location in which the UE 200a is located in S33, the server processing unit 150 of the server apparatus 100 transmits, to the UE 200a, a control message including area IDs for identifying the geographical area in which the UE 200a is located and neighboring areas thereof in S34. Note that in a case where the UE 200a can autonomously determine the areas, the area notification in S34 may be omitted. Here, it is assumed that the UE 200a is determined to be located in the place where it should relay an alarm message because it is located near the boundary between the first and second geographical areas for which the risk level data 130 indicates a high risk level. Then, in S36, the server processing unit 150 requests the base station 300 serving the first geographical area in which the UE 200a is located to broadcast control information for instructing the V2X UEs in the first geographical area to relay an alarm message. In S38, the communication control unit 310 of the base station 300 that has received the broadcast request causes the radio I/F 301 to broadcast the control information indicating that a V2X UE located in the first geographical area and located in or near the second geographical area should relay an alarm message via the sidelink. The client processing unit 220 of the UE 200a receives this control information via the radio I/F 201.

The subsequent processing steps of S41 to S49 may be similar to the corresponding processing steps in the first embodiment example described with reference to FIG. 9. Therefore, descriptions of these processing steps are omitted here.

### 4. Summary of Embodiments

The above embodiments disclose at least the following server apparatus, communication control methods, terminal apparatus, and base station.
1. A server apparatus (100) of the above embodiments comprises:
a communication unit (101) adapted to communicate with one or more terminal apparatuses (200) that operate as clients of a vehicle-to-everything, V2X, application, and
a server processing unit (150) adapted to operate as a server of the V2X application,
wherein the server processing unit is capable of accessing a database (110) that indicates a neighbor relationship (120) between geographical areas for a plurality of geographical areas (121-1, 121-2, 121-3, 121-4) predefined for the V2X application, a first geographical area and a second geographical area being indicated as neighboring areas by the database, and
the server processing unit is adapted to:
   configure (S25) each of the one or more terminal apparatuses to receive, via a sidelink, an alarm message regarding road safety sent from another terminal apparatus;
   receive (S31) location information of a first terminal apparatus via the communication unit;
   determine (S33), on the basis of the location information, that the first terminal apparatus is located in the first geographical area; and
   instruct (S35, S36) the first terminal apparatus to relay, via the sidelink, the alarm message received in the first geographical area so that a second terminal apparatus located in the second geographical area can receive the relayed alarm message.

According to this embodiment, it is possible to extend a range within which an alarm message for notifying of a presence of a threat is reachable by using the sidelink of the terminal apparatus to relay the message. Since the relayed alarm message is transmitted from the first geographical area to the second geographical area without going through a base station, it takes only a small latency for the relay. Therefore, users of V2X UEs in a broader range can be timely notified of the presence of the threat, which further improves user's safety related to road traffic.
2. In the above embodiments, instructing the first terminal apparatus to relay the alarm message may include
transmitting (S35), via the communication unit to the first terminal apparatus, a control message to instruct relaying the alarm message upon determining that the first terminal apparatus is located in the first geographical area and located in the second geographical area or near the second geographical area.

According to this embodiment, the communication for controlling relay operation of the terminal apparatus is performed at an application level between the server and the client of the V2X application. That is, the content of the communication is transparent to the base station located along the communication path. Therefore, it is possible to define a plurality of geographical areas on the basis of the situation of road traffic and to achieve control of the relay operation in units of the geographical areas without being affected by the arrangement of the base stations.
3. In the above embodiments, instructing the first terminal apparatus to relay the alarm message may include
requesting (S36) a base station serving the first geographical area to broadcast control information indicating that the alarm message should be relayed by a terminal apparatus that operates as a client of the V2X application and is located in the first geographical area and located in the second geographical area or near the second geographical area.

According to this embodiment, as one or a plurality of terminal apparatuses that have received the control information broadcast by the base station relay the alarm message, the reachable range of the alarm message can be more widely and efficiently extended.
4. In the above embodiments, the database may further indicate a risk level (130) for each of the plurality of geographical areas, and
the server processing unit may be adapted to determine that the alarm message received in the first geographical area should also be received in the second geographical area in a case where a risk level of the second geographical area indicated by the database satisfies a predetermined criterion.

According to this embodiment, the reachable range of the alarm message can be adaptively extended toward areas where the user's safety is likely to be threatened, such as areas with many obstacles blocking the line of sight or areas with many pedestrians. Therefore, sufficient safety can be achieved while avoiding excessive consumption of communication resources due to relaying of alarm messages.
5. In the above embodiments, the server processing unit may be adapted to determine that the alarm message received in the first geographical area should also be received in the second geographical area in a case where both of a risk level of the first geographical area and a risk level of the second geographical area indicated by the database satisfy the predetermined criterion.

According to this embodiment, for an alarm message generated in an area with a relatively high risk level, the reachable range thereof can be adaptively extended towards areas where the user's safety is likely to be threatened because of their similarly relatively high risk levels.
6. A communication control method of the above embodiments is a communication control method, performed by a server apparatus (100) that operates as a server of a vehicle-to-everything, V2X, application, for controlling V2X communication by a terminal apparatus (200) that operates as a client of the V2X application,
wherein the server apparatus is capable of accessing a database (110) that indicates a neighbor relationship (120) between geographical areas for a plurality of geographical areas (121-1, 121-2, 121-3, 121-4) predefined for the V2X application, a first geographical area and a second geographical area being indicated as neighboring areas by the database, and
the communication control method comprising:
   configuring (S25) each of one or more terminal apparatuses to receive, via a sidelink, an alarm message regarding road safety sent from another terminal apparatus;
   receiving (S31) location information of a first terminal apparatus;
   determining (S33), on the basis of the location information, that the first terminal apparatus is located in the first geographical area; and
   instructing (S35, S36) the first terminal apparatus to relay, via the sidelink, the alarm message received in the first geographical area so that a second terminal apparatus located in the second geographical area can receive the relayed alarm message.

According to this embodiment, it is possible to extend a range within which an alarm message for notifying of a presence of a threat is reachable by using the sidelink of the terminal apparatus to relay the message. Since the relayed alarm message is transmitted from the first geographical area to the second geographical area without going through a base station, it takes only a small latency for the relay. Therefore, users of V2X UEs in a broader range can be timely notified of the presence of the threat, which further improves user's safety related to road traffic.
7. A terminal apparatus (200) of the above embodiments comprises:
a radio communication unit (201) adapted to perform radio communication via a radio link between the terminal apparatus and a base station (300) and a sidelink between the terminal apparatus and another terminal apparatus (200); and
a client processing unit (220) adapted to operate as a client of a vehicle-to-everything, V2X, application and connect, via the radio link of the radio communication unit, to a server apparatus (100) that operates as a server of the V2X application,
wherein the server apparatus is capable of accessing a database (110) that indicates a neighbor relationship (120) between geographical areas for a plurality of geographical areas (121-1, 121-2, 121-3, 121-4) predefined for the V2X application, a first geographical area and a second geographical area being indicated as neighboring areas by the database, and
the client processing unit is adapted to:
   set up (S25) the radio communication unit to receive, via the sidelink, an alarm message regarding road safety sent from such another terminal apparatus;
   transmit (S31) location information of the terminal apparatus to the server apparatus;
   receive (S35, S38) an instruction to relay the alarm message via the sidelink when it is determined by the server apparatus, on the basis of the location information, that the terminal apparatus is located in the first geographical area; and
   relay (S47), via the sidelink of the radio communication unit, the alarm message received in the first geographical area so that a terminal apparatus located in the second geographical area can receive the relayed alarm message.

According to this embodiment, the terminal apparatus relays, via the sidelink, the alarm message for notifying of a presence of a threat in accordance with control from the server apparatus in a case where it is located in the first geographical area neighboring the second geographical area. This extends the reachable range of the alarm message to a range that spans across the first and second geographical areas. Since the alarm message is relayed without going through a base station, it takes only a small latency for the relay. Therefore, users of V2X UEs in a broader range can be timely notified of the presence of the threat, which further improves user's safety related to road traffic.
8. In the above embodiments, the client processing unit may be adapted to receive (S35), from the server apparatus via the radio link of the radio communication unit as a response to the transmitted location information, a control message that instructs to relay the alarm message.

According to this embodiment, the control message for controlling relay operation of the terminal apparatus is received through communication at an application level from the server apparatus. Therefore, it is possible to provide control of the relay operation in units of the geographical areas without being affected by the arrangement of the base stations.
9. In the above embodiments, the client processing unit may be adapted to receive the control message from the server apparatus when it is determined by the server apparatus that the terminal apparatus is located in the first geographical area and located in the second geographical area or near the second geographical area.

According to this embodiment, the reachable range of the alarm message can be adaptively extended toward areas where the user's safety is likely to be threatened. Therefore, sufficient safety can be achieved while avoiding excessive consumption of communication resources due to relaying of alarm messages.
10. In the above embodiments, the radio communication unit may be adapted to receive (S38) control information broadcast by a base station upon a request from the server apparatus, the base station serving the first geographical area, and
the control information indicates that the alarm message should be relayed by a terminal apparatus operating as a client of the V2X application and located in the first geographical area and located in the second geographical area or near the second geographical area.

According to this embodiment, extension of the range can be efficiently achieved because there is no need for the server apparatus to transmit a dedicated control message to each terminal apparatus in order to extend the reachable range of the alarm message.
11. A communication control method of the above embodiments is a communication control method, performed by a terminal apparatus (200) that operates as a client of a vehicle-to-everything, V2X, application, for controlling V2X communication by the terminal apparatus,
wherein the terminal apparatus includes a radio communication unit (201) adapted to perform radio communication via a radio link between the terminal apparatus and a base station (300) and a sidelink between the terminal apparatus and another terminal apparatus (200), the radio communication unit connecting, via the radio link of the radio communication unit, to a server apparatus (100) that operates as a server of the V2X application,
the server apparatus is capable of accessing a database (110) that indicates a neighbor relationship (120) between geographical areas for a plurality of geographical areas (121-1, 121-2, 121-3, 121-4) predefined for the V2X application, a first geographical area and a second geographical area being indicated as neighboring areas by the database, and
the communication control method comprising:
   setting (S25) up the radio communication unit to receive, via the sidelink, an alarm message regarding road safety sent from such another terminal apparatus;
   transmitting (S31) location information of the terminal apparatus to the server apparatus;
   receiving (S35, S38) an instruction to relay the alarm message via the sidelink when it is determined by the server apparatus, on the basis of the location information, that the terminal apparatus is located in the first geographical area; and
   relaying (S47), via the sidelink of the radio communication unit, the alarm message received in the first geographical area so that a terminal apparatus located in the second geographical area can receive the relayed alarm message.

According to this embodiment, the terminal apparatus relays, via the sidelink, the alarm message for notifying of a presence of a threat in accordance with control from the server apparatus in a case where it is located in the first geographical area neighboring the second geographical area. This extends the reachable range of the alarm message to a range that spans across the first and second geographical areas. Since the alarm message is relayed without going through a base station, it takes only a small latency for the relay. Therefore, users of V2X UEs in a broader range can be timely notified of the presence of the threat, which further improves user's safety related to road traffic.
12. A base station (300) of the above embodiments comprises:
a radio communication unit (301) adapted to perform radio communication in at least a first geographical area out of a plurality of geographical areas (121-1, 121-2, 121-3, 121-4) predefined for a vehicle-to-everything, V2X, application;
a network communication unit (302) adapted to perform communication with a server apparatus (100) that operates as a server of the V2X application; and
a control unit (310) adapted to control communication performed by the radio communication unit and the network communication unit,
wherein the server apparatus is capable of accessing a database (110) that indicates a neighbor relationship (120) between geographical areas for a plurality of geographical areas predefined for the V2X application, the first geographical area and a second geographical area being indicated as neighboring areas by the database, and
the control unit is adapted to cause (S38), upon a request from the server apparatus, the radio communication unit to broadcast control information indicating that a terminal apparatus (200) operating as a client of the V2X application and located in the first geographical area and located in the second geographical area or near the second geographical area should relay, via a sidelink, an alarm message regarding road safety sent from another terminal apparatus when the terminal apparatus has received the alarm message via the sidelink.

According to this embodiment, it is possible to configure one or a plurality of terminal apparatuses that are located near a boundary between the first and second geographical area to relay the alarm message for notifying of a presence of a threat through control information broadcasting from the base station. This can extend the reachable range of the alarm message to a broader range that spans across the two geographical areas. Therefore, users of V2X UEs in a broader range can be timely notified of the presence of the threat, which further improves user's safety related to road traffic.
13. In the above embodiments, the control unit may be adapted to cause the radio communication unit to include the control information in a system information block for control of V2X communication and broadcast the control information.

According to this embodiment, a terminal apparatus not involved in V2X communication can ignore the system information block carrying the control information. Therefore, the addition of the control information broadcast by the base station does not increase processing load in a terminal apparatus that does not benefit from the alarm message.
14. A communication control method of the above embodiments is a communication control method, performed by a base station (300), for controlling V2X communication by a terminal apparatus (200) that operates as a client of a vehicle-to-everything, V2X, application,
wherein the base station includes a radio communication unit (301) adapted to perform radio communication in at least a first geographical area out of a plurality of geographical areas (121-1, 121-2, 121-3, 121-4) predefined for the V2X application, and a network communication unit (302) adapted to perform communication with a server apparatus that operates as a server of the V2X application,
the server apparatus is capable of accessing a database (110) that indicates a neighbor relationship (120) between the geographical areas, the first geographical area and a second geographical area being indicated as neighboring areas by the database, and
the communication control method comprising:
receiving (S36) a request message from the server apparatus via the network communication unit; and
upon receiving the request message, causing (S38) the radio communication unit to broadcast control information indicating that a terminal apparatus located in the first geographical area and located in the second geographical area or near the second geographical area should relay, via a sidelink, an alarm message regarding road safety received from another terminal apparatus.

According to this embodiment, it is possible to configure one or a plurality of terminal apparatuses that are located near a boundary between the first and second geographical area to relay the alarm message for notifying of a presence of a threat through control information broadcasting from the base station. This can extend the reachable range of the alarm message to a broader range that spans across the two geographical areas. Therefore, users of V2X UEs in a broader range can be timely notified of the presence of the threat, which further improves user's safety related to road traffic.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A server apparatus comprising:
a communication unit adapted to communicate with one or more terminal apparatuses that operate as clients of a vehicle-to-everything, V2X, application, and
a server processing unit adapted to operate as a server of the V2X application, wherein
the server processing unit is capable of accessing a database that indicates a neighbor relationship between geographical areas for a plurality of geographical areas predefined for the V2X application, a first geographical area and a second geographical area being indicated as neighboring areas by the database, and
the server processing unit is adapted to:
configure each of the one or more terminal apparatuses to receive, via a sidelink, an alarm message regarding road safety sent from another terminal apparatus;
receive location information of a first terminal apparatus via the communication unit;
determine, on the basis of the location information, that the first terminal apparatus is located in the first geographical area; and
instruct the first terminal apparatus to relay, via the sidelink, the alarm message received in the first geographical area so that a second terminal apparatus located in the second geographical area can receive the relayed alarm message.

2. The server apparatus according to claim 1, wherein instructing the first terminal apparatus to relay the alarm message includes
transmitting, via the communication unit to the first terminal apparatus, a control message to instruct relaying the alarm message upon determining that the first terminal apparatus is located in the first geographical area and located in the second geographical area or near the second geographical area.

3. The server apparatus according to claim 1, wherein instructing the first terminal apparatus to relay the alarm message includes
requesting a base station serving the first geographical area to broadcast control information indicating that the alarm message should be relayed by a terminal apparatus that operates as a client of the V2X application and is located in the first geographical area and located in the second geographical area or near the second geographical area.

4. The server apparatus according to claim 1, wherein the database further indicates a risk level for each of the plurality of geographical areas, and
the server processing unit is adapted to determine that the alarm message received in the first geographical area should also be received in the second geographical area in a case where a risk level of the second geographical area indicated by the database satisfies a predetermined criterion.

5. The server apparatus according to claim 4, wherein the server processing unit is adapted to determine that the alarm message received in the first geographical area should also be received in the second geographical area in a case where both of a risk level of the first geographical area and a risk level of the second geographical area indicated by the database satisfy the predetermined criterion.

6. A communication control method, performed by a server apparatus that operates as a server of a vehicle-to-everything, V2X, application, for controlling V2X communication by a terminal apparatus that operates as a client of the V2X application,
the server apparatus being capable of accessing a database that indicates a neighbor relationship between geographical areas for a plurality of geographical areas predefined for the V2X application, a first geographical area and a second geographical area being indicated as neighboring areas by the database, and
the communication control method comprising:
configuring each of one or more terminal apparatuses to receive, via a sidelink, an alarm message regarding road safety sent from another terminal apparatus;
receiving location information of a first terminal apparatus;
determining, on the basis of the location information, that the first terminal apparatus is located in the first geographical area; and
instructing the first terminal apparatus to relay, via the sidelink, the alarm message received in the first geographical area so that a second terminal apparatus located in the second geographical area can receive the relayed alarm message.

7. A terminal apparatus comprising:
a radio communication unit adapted to perform radio communication via a radio link between the terminal apparatus and a base station and a sidelink between the terminal apparatus and another terminal apparatus; and
a client processing unit adapted to operate as a client of a vehicle-to-everything, V2X, application and connect, via the radio link of the radio communication unit, to a server apparatus that operates as a server of the V2X application,
wherein the server apparatus is capable of accessing a database that indicates a neighbor relationship between geographical areas for a plurality of geographical areas predefined for the V2X application, a first geographical area and a second geographical area being indicated as neighboring areas by the database, and
the client processing unit is adapted to:
set up the radio communication unit to receive, via the sidelink, an alarm message regarding road safety sent from such another terminal apparatus;
transmit location information of the terminal apparatus to the server apparatus;
receive an instruction to relay the alarm message via the sidelink when it is determined by the server apparatus, on the basis of the location information, that the terminal apparatus is located in the first geographical area; and
relay, via the sidelink of the radio communication unit, the alarm message received in the first geographical area so that a terminal apparatus located in the second geographical area can receive the relayed alarm message.

8. The terminal apparatus according to claim 7, wherein the client processing unit is adapted to receive, from the server apparatus via the radio link of the radio communication unit as a response to the transmitted location information, a control message that instructs to relay the alarm message.

9. The terminal apparatus according to claim 8, wherein the client processing unit is adapted to receive the control message from the server apparatus when it is determined by the server apparatus that the terminal apparatus is located in the first geographical area and located in the second geographical area or near the second geographical area.

10. The terminal apparatus according to claim 7, wherein the radio communication unit is adapted to receive control information broadcast by a base station upon a request from the server apparatus, the base station serving the first geographical area, and
the control information indicates that the alarm message should be relayed by a terminal apparatus operating as a client of the V2X application and located in the first geographical area and located in the second geographical area or near the second geographical area.

11. A communication control method, performed by a terminal apparatus that operates as a client of a vehicle-to-everything, V2X, application, for controlling V2X communication by the terminal apparatus,
wherein the terminal apparatus includes a radio communication unit adapted to perform radio communication via a radio link between the terminal apparatus and a base station and a sidelink between the terminal apparatus and another terminal apparatus,
the radio communication unit connecting, via the radio link of the radio communication unit, to a server apparatus that operates as a server of the V2X application,
the server apparatus being capable of accessing a database that indicates a neighbor relationship between geographical areas for a plurality of geographical areas predefined for the V2X application, a first geographical area and a second geographical area being indicated as neighboring areas by the database, and
the communication control method comprising:
setting up the radio communication unit to receive, via the sidelink, an alarm message regarding road safety sent from such another terminal apparatus;
transmitting location information of the terminal apparatus to the server apparatus;
receiving an instruction to relay the alarm message via the sidelink when it is determined by the server apparatus, on the basis of the location information, that the terminal apparatus is located in the first geographical area; and
relaying, via the sidelink of the radio communication unit, the alarm message received in the first geographical area so that a terminal apparatus located in the second geographical area can receive the relayed alarm message.

12. A base station comprising:
a radio communication unit adapted to perform radio communication in at least a first geographical area out of a plurality of geographical areas predefined for a vehicle-to-everything, V2X, application;
a network communication unit adapted to perform communication with a server apparatus that operates as a server of the V2X application; and
a control unit adapted to control communication performed by the radio communication unit and the network communication unit,
wherein the server apparatus is capable of accessing a database that indicates a neighbor relationship between geographical areas for a plurality of geographical areas predefined for the V2X application, the first geographical area and a second geographical area being indicated as neighboring areas by the database, and
the control unit is adapted to:
cause, upon a request from the server apparatus, the radio communication unit to broadcast control information indicating that a terminal apparatus operating as a client of the V2X application and located in the first geographical area and located in the second geographical area or near the second geographical area should relay, via a sidelink, an alarm message regarding road safety sent from another terminal apparatus when the terminal apparatus has received the alarm message via the sidelink.

13. The base station according to claim 12, wherein the control unit is adapted to cause the radio communication unit to include the control information in a system information block for control of V2X communication and broadcast the control information.

14. A communication control method, performed by a base station, for controlling V2X communication by a terminal apparatus that operates as a client of a vehicle-to-everything, V2X, application,
wherein the base station includes a radio communication unit adapted to perform radio communication in at least a first geographical area out of a plurality of geographical areas predefined for the V2X application, and a network communication unit adapted to perform communication with a server apparatus that operates as a server of the V2X application,
the server apparatus is capable of accessing a database that indicates a neighbor relationship between the geographical areas, the first geographical area and a second geographical area being indicated as neighboring areas by the database, and
the communication control method comprising:
receiving a request message from the server apparatus via the network communication unit; and
upon receiving the request message, causing the radio communication unit to broadcast control information indicating that a terminal apparatus located in the first geographical area and located in the second geographical area or near the second geographical area should relay, via a sidelink, an alarm message regarding road safety received from another terminal apparatus.
